(19) United States
(12) Patent Application Publication
(10) Pub. No.: US 2021/0042685 A1
(43) Pub. Date: Feb. 11, 2021

(54) SMART STORAGE EQUIPMENT FOR SMART LOGTISTICS SYSTEM AND SMART LOGISTICS METHOD USING THE SAME

(71) Applicant: Ming-Hsien Chiu, New Taipei City (TW)

(72) Inventors: Ming-Hsien Chiu, New Taipei City (TW); Yu-Wen Han, Taoyuan City (TW)

(21) Appl. No.: 16/920,659

(22) Filed: Jul. 4, 2020

(30) Foreign Application Priority Data
Aug. 6, 2019 (TW) 108210388

(51) Int. Cl. G06Q 10/08; G07C 9/00; A47G 29/14

(52) U.S. Cl. CPC G06Q 10/083; G07C 9/00182; A47G 2029/149; A47G 2029/145; A47G 29/141

(57) ABSTRACT

A smart storage equipment for smart logistics system and a smart logistics method using the same are provided. The smart storage equipment has a base device and at least one logistic container (such as, but not limited to, a logistic container with thermal insulation). The logistic container is loaded with goods and accommodated in a container-storage structure of the base device. Based on a validity of an identification information of the logistic container, the logistic container is further locked or unlocked to the container-storage structure of the base device. Furthermore, based on whether a consumer information of a consumer and the identification information of the logistic container match an order information in a server, a transceiver control unit of the logistic container controls a cover lock of the logistic container to unlock or lock.

### REFERENCE TO RELATED APPLICATIONS

This non-provisional application claims priority claim under 35 U.S.C. § 119(a) on Taiwan Patent Application No. 108210388 filed on Aug. 6, 2019, and the entire contents of which are incorporated herein by reference.

### FIELD

The present disclosure relates to a smart storage equipment for smart logistics system and a smart logistics method using the smart storage equipment, more particularly, to a smart storage equipment for smart logistics system and a smart logistics method using the smart storage equipment that allow goods to be delivered and picked up respectively by vendors (sellers) and consumers (buyers) separately at their own paces to save their time spent on the entire delivery process.

### BACKGROUND

Along with the internet contents and services being more and more associated to our everyday living, online shopping has also become an activity that is inseparable from our daily lives. Online shopping platforms, models and deliveries of different types are prospering, and besides the common delivery of goods, there are deliveries that specialize in fresh or perishable ingredients and cooked foods/hot meals.

Currently, deliveries of goods can be categorized into two ways: face-to-face delivery and pick-up point delivery. The face-to-face deliver is where a delivery person of a logistic operator and a consumer meet in person to handover goods and perhaps to take payments like cash-on-delivery, however, restricted delivery time is an issue for both the logistic operator and the consumer and often one has to wait for another during the delivery. The pick-up point delivery is where the goods is delivered to a third-party platform like convenient stores for pick-up by the consumer, which not only raises delivery cost, lining-up at the convenient store for picking up the goods does not save the consumer's time, and often the clerk at the convenient store would spend a lot of time search for the goods, making the pick-up process low in efficiency.

In addition, the conventional deliveries of fresh foods and cooked foods/hot meals are mostly by the face-to-face delivery, which lacks efficiency during the pick-up process. Moreover, during the delivery of foods and meals, the goods are prone to be opened or touched easily and hygienic issue may be a concern.

### SUMMARY

Therefore, to solve the aforementioned issues, the present disclosure provides a smart storage equipment for smart logistics system and a smart logistic method using the smart storage equipment. The smart storage equipment includes a base device and at least one logistic container, wherein the logistic container is loaded with goods and accommodated in a container-storage structure of the base device, and the smart logistic method controls whether the logistic container is locked or not to the container-storage structure of the base device based on a validity of an identification information of the logistic container. Moreover, the logistic container includes a transceiver control unit, where the smart logistic method controls whether a cover lock of the logistic container is unlocked or not based on whether a consumer information of a consumer and the identification information of the logistic container match a pick-up information in a server. The smart storage equipment for smart logistic system and the smart logistic method using the smart storage equipment save time for vendors (sellers) and consumers (buyers) by allowing them to deliver and pick-up goods separately and independent of each other's schedule. Moreover, the logistic container has a cover lock and the unlocking of which is based on the order information, the consumer information and the identification information being matched, and thus the concern of the goods being touched by a third party such as the delivery person of the logistic operator is lowered to reduce possible factors contributing to consumer disputes and food safety issues about fresh ingredients and hot meals.

An object of the present disclosure is to provide a smart storage equipment for smart logistic system that includes a base device and at least one logistic container. The base device includes a base and a communication unit, wherein the base has a plurality of container-storage structures and the communication unit is disposed in the base. Each of the plurality of container-storage structures has disposed therein a container lock and an identification control unit. The identification control unit is electrically connected to the communication unit and the communication unit is communicatively connected to a server. The logistic container includes a cover, a container body, and a cover lock, wherein the cover lock is used to lock the cover and the container body. The container body has an identification information and further has disposed therein a base lock corresponding to the container lock and a transceiver control unit. When the logistic container is placed in the container-storage structure, the transceiver control unit sends the identification information of the logistic container to the identification control unit of the container-storage structure, and a locking between the container lock and the base lock is based on a validity of the identification information. The transceiver control unit controls an unlocking of the cover lock based on whether a consumer information of a consumer and the identification information of the logistic container match a pick-up information in the server.

Another object of the present disclosure is to provide a smart logistic method using smart storage equipment that has the following steps. First, a smart storage equipment having a base device and at least one logistic container is provided, wherein the base device includes a base with a plurality of container-storage structures and a communication unit disposed in the base. Each of the plurality of container-storage structures has disposed therein a container lock and an identification control unit, wherein the identification control unit is electrically connected to the communication unit and the communication unit is communicatively connected to a server. The logistic container includes a cover, a container body and a cover lock, wherein the cover lock is for locking the cover and the container body. The container body has identification information and includes a base lock corresponding to the container lock and a transceiver control unit disposed therein. Second, the logistic container is placed in the container-storage structure. Third, the transceiver control unit sends the identification information of the logistic container to the identification control unit of the container-storage structure and a locking between the container lock and the base lock is controlled based on a validity of the identification information. Last, the transceiver control unit controls an unlocking of the cover lock based on whether a consumer information of a consumer and the identification information of the logistic container match a pick-up information in the server.

Preferably, the server obtains an order information from a first electronic device of the consumer and sends the order information to a second electronic device of a vendor corresponding to the order information. After a good corresponding to the order information is put into the logistic container by the vendor and the identification information is obtained through the second electronic device, the transceiver control unit controls the cover lock to lock the cover and the container body and the second electronic device sends the identification information to the server to form a package information, wherein the order information includes the consumer information, a vendor information, a goods information, and a base-device-identification information, and the package information includes the order information and the identification information.

Preferably, the identification control unit of the container-storage structure sends the identification information to the communication unit, and the communication unit sends the identification information and the base-device-identification information to the server such that the server determines the validity of the identification information by matching the identification information and the base-device-identification information to the package information and generates and sends a first determination result to the communication unit. The communication unit sends the first determination result to the identification control unit and the identification control unit controls the locking between the container lock and the base lock according to the first determination result.

Preferably, when the identification information is valid, the identification control unit enforces the locking between the container lock and the base lock and sends the identification information of the logistic container and a container-storage-structure-identification information of the container-storage structure to the server through the communication unit to generate the pick-up information. The server sends the container-storage-structure-identification information of the container-storage structure to the first electronic device of the consumer, wherein the pick-up information includes the package information and the container-storage-structure-identification information. When the identification information is invalid, the identification control unit controls the container-storage structure to eject the logistic container.

Preferably, the first electronic device of the consumer obtains the identification information and sends the consumer information and the identification information to the server, and the server determines whether the consumer information and the identification information match the pick-up information and generates a second determination result to the communication unit. The communication unit sends the second determination result to the transceiver control unit through the identification control unit and the transceiver control unit controls the unlocking of the cover lock according to the second determination result.

Preferably, when the consumer information and the identification information match the pick-up information, the server sends the container-storage-structure-identification information of the container-storage structure to the communication unit so that the communication unit sends the second determination result based on the container-storage-structure-identification information to the transceiver control unit and the transceiver control unit unlocks the cover lock. When the consumer information and the identification information do not match the pick-up information, the transceiver control unit does not unlock the cover lock and the server sends a first prompt message to the consumer.

Preferably, the identification information is stored in the transceiver control unit and the logistic container further includes a barcode marked on the container body, wherein the barcode contains the identification information.

Preferably, a personnel information of a delivery person is sent to the communication unit, and a release of the locking between the base lock and the container lock of the logistic container with unlocked cover lock is controlled according to the personnel information, and the logistic container is ejected from the container-storage structure after the locking between the base lock and the container lock of the logistic container with unlocked cover lock is released or unlocked.

Preferably, the communication unit sends the personnel information to the server and the server determines a validity of the personnel information and generates a third determination result to the communication unit. When the personnel information is valid, the locking between the base lock and the container lock of the logistic container with unlocked cover lock is unlocked/released and the unlocked/released logistic container is ejected from the container-storage structure. When the personnel information is invalid, the communication unit sends a second prompt message to the delivery person.

Preferably, the logistic container is a logistic container with thermal insulation.

Preferably, the logistic container further includes a battery for providing electrical power or an induction circuit for sensing electromagnetic waves to obtain electrical power.

Another object of the present disclosure is to provide a smart logistic system that includes the aforementioned smart storage equipment and a server.

As stated above, the present disclosure provides a smart storage equipment for smart logistic system and a smart logistic method using smart storage equipment that save the time consumed by the delivery person of the logistic operator and the consumer due to delivery and pick-up of goods, and through the cover lock of the logistic container, the chance of the goods in the logistic container being touched by others is reduced. Thus, the smart storage equipment and the smart logistic method of the present disclosure are advantageous in markets with logistic distribution needs, such as commercial stores and food industry.

### BRIEF DESCRIPTION OF THE DRAWINGS

The structure as well as preferred modes of use, further objects, and advantages of this present disclosure will be best understood by referring to the following detailed description of some illustrative embodiments in conjunction with the accompanying drawings, in which:

FIG. 1 is a schematic diagram of a base device of a smart storage equipment for smart logistic system according to an embodiment of the present disclosure.

FIG. 2A is a schematic diagram of a logistic container of a smart storage equipment for smart logistic system according to an embodiment of the present disclosure.

FIG. 2B is a rear schematic view of a logistic container of a smart storage equipment for smart logistic system according to an embodiment of the present disclosure.

FIG. 3 is a schematic diagram illustrating signal connections of a smart storage equipment for smart logistic system according to an embodiment of the present disclosure.

FIG. 4 is a flow chart illustrating meal or merchandise ordering and order preparation processes in a smart logistic method according to an embodiment of the present disclosure.

FIG. 5 is a flow chart illustrating meal or merchandise delivery process in a smart logistic method according to an embodiment of the present disclosure.

FIG. 6 is a flow chart illustrating meal or merchandise pick-up process in a smart logistic method according to an embodiment of the present disclosure.

FIG. 7 is a flow chart illustrating logistic container retrieving process in a smart logistic method according to an embodiment of the present disclosure.

### DETAILED DESCRIPTION OF THE PREFERRED EMBODIMENTS

The present disclosure provides a smart storage equipment for smart logistic system and a smart logistic method using the smart storage equipment, wherein the smart storage equipment includes a base device and at least one logistic container. When a consumer orders goods like articles or foods, a vendor, like a store or a business, can put the goods in the logistic container of the smart storage equipment and after a server of the smart logistic system has obtained an identification information, locks the logistic container through its cover lock. Then a delivery person, like that of a logistic operator, delivers the logistic container to the base device designated by the consumer and places the logistic container in a container-storage structure of the base device, and once an identification information is determined to be valid, the logistic container is locked in the container-storage structure and awaits for the consumer to pick up the goods which the consumer ordered. Subsequently, the consumer sends the identification information and a consumer information to the server, and when the server determines the identification information and the consumer information match a pick-up information, the cover lock of the logistic container is unlocked/opened so the consumer is able to take out the goods inside. After the consumer has picked up the goods, the delivery person sends a personnel information to the server, and when the server determines the personnel information is valid, the locking between the logistic container and the container-storage structure is released/unlocked so the delivery person can recycle/retrieve the logistic container and use it for next order.

The present disclosure is described using meal or merchandise ordering, meal or merchandise delivery, and meal or merchandise pick-up as illustration, but the present disclosure is not limited by the types of goods in logistics. The smart storage equipment for smart logistic system saves the time of the delivery person and the consumer by allowing the delivery to be complete without them having to meet in person. In addition, since the smart storage equipment has multiple container-storage structures and logistic containers, and each logistic container has its own and unique identification information, the smart storage equipment provides a platform where multiple consumers can pick up their ordered goods at the same location and at the same time. Therefore, the smart storage equipment for smart logistic system and the smart logistic method using the smart storage equipment as described by the present disclosure have the potential to replace the current and common logistic model of pick-up point (convenient store) delivery which cannot allow multiple consumers to pick up goods at the same time and location, and to eliminate the time spent by the consumer on waiting in line when pick up their goods.

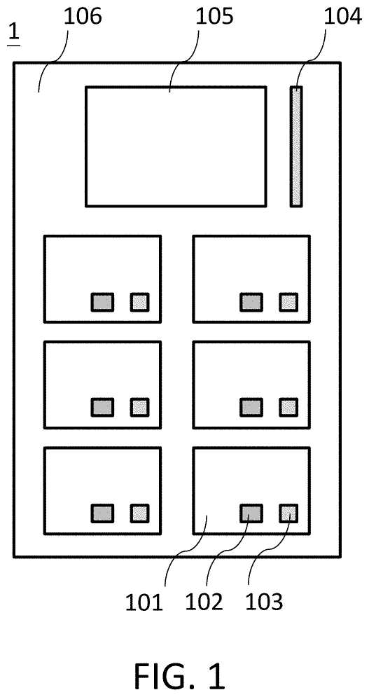

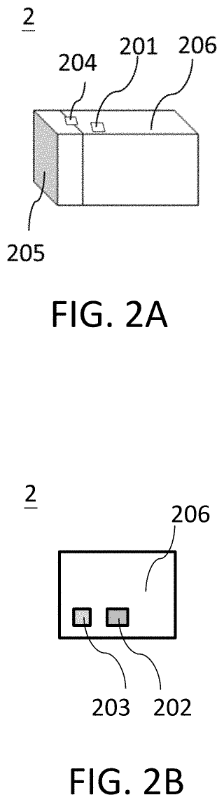

FIG. 1, FIG. 2A and FIG. 2B are respectively a schematic diagram of a base device, a schematic diagram of a logistic container of a smart storage equipment and a rear view of the logistic container in FIG. 2A viewing from the right side to the left side according to an embodiment of the present disclosure. As shown in FIG. 1, the base device 1 of the smart storage equipment includes a base 106, a plurality of container-storage structures 101, and a display 105, wherein a communication unit 104 is disposed in the base 106, and each of the container-storage structures 101 has a container lock 102 and an identification control unit 103 disposed therein. The display 105 is capable of displaying information related to delivery and pick-up as references for consumers or delivery persons, but the display 105 is not an essential element of the present disclosure. As shown in FIG. 2A and FIG. 2B, the logistic container 2 of the smart storage equipment includes a container body 206, a cover 205, a cover lock 204, a base lock 202, a transceiver control unit 203 and a barcode 201 containing identification information, wherein the cover lock 204 is used to lock the cover 205 and the container body 206 and the cover lock 204 is an electric lock. The barcode 201 is, for example, two-dimensional barcode or quick response code (QR code), and is not an essential element of the present disclosure as the identification information can be read by near-field communication or other methods. In a validated situation, the container lock 102 of the container-storage structure 101 of the base 106 is permitted to lock correspondingly with the base lock 202 of the logistic container 202. One of the container lock 102 of the container-storage structure 101 and the base lock 202 of the logistic container 2 is metal and the other one is electromagnet, but the present disclosure is not limited thereby, they can also be lock structures that correspond to each other and one or both of them can be driven by electrical power to execute locking and unlocking.

The logistic container 2 is a logistic container with thermal insulation to ensure the freshness of the goods in the logistic container, wherein the thermal insulation functions to maintain temperature so as to keep the goods hot and/or cold, and the present disclosure is not limited by the logistic container 2 having the thermal insulation capability or not. Moreover, a replaceable or chargeable battery is disposed in the logistic container 2 to obtain electrical power, or no battery is disposed in the logistic container 2 but instead an induction circuit that is capable of conducting wireless detection at near-field and obtains electrical power. The present disclosure does not limit the method which the logistic container 2 uses to obtain electrical power.

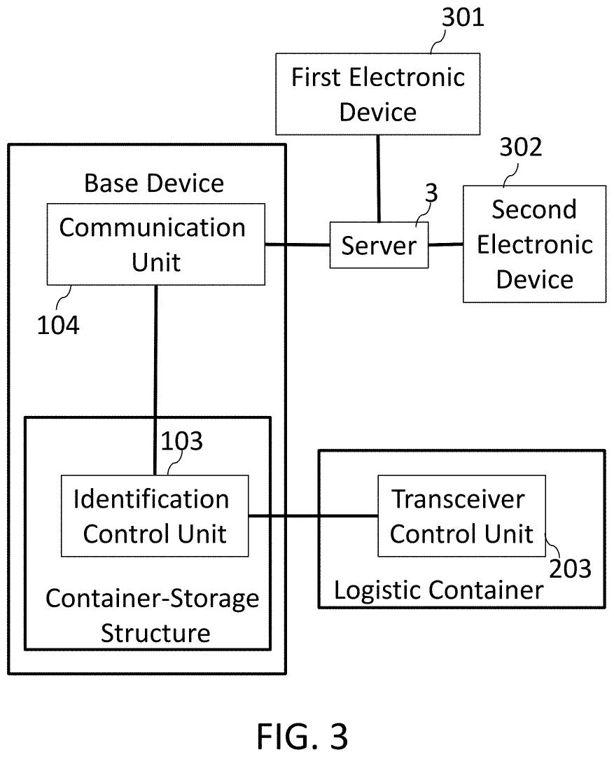

Referring to FIG. 3, a smart logistic system includes the smart storage equipment, which has the base device 1 and the logistic container 2, and a server 3. The communication unit 104 of the base device 1 is communicatively connected to the server 3 and is electrically connected to the identification control unit 103, and the identification control unit 103 of the base device 1 is communicatively connected to the transceiver control unit 203 of the logistic container 2. When a consumer uses a first electronic device 301 to access the smart logistic system, the first electronic device 301 is communicatively connected to the server 3. When a vendor uses a second electronic device 302 to access the smart logistic system, the second electronic device 302 is in communication with the server 3.

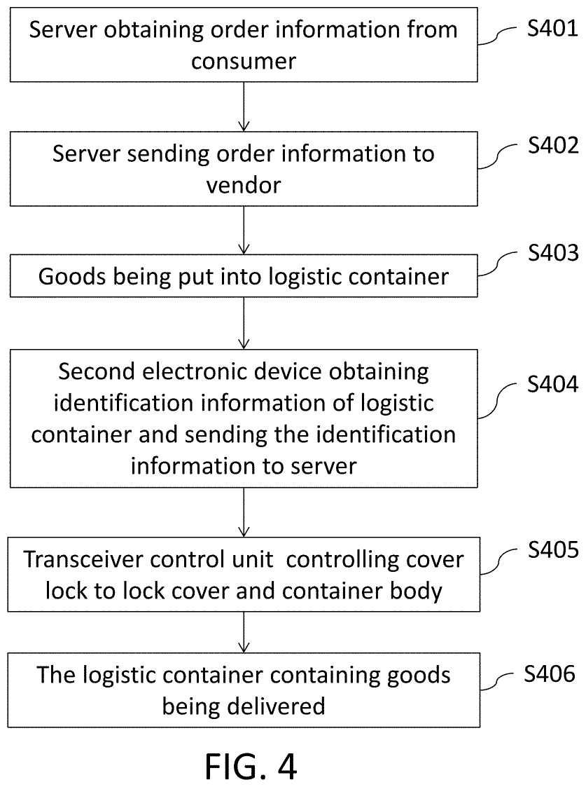

In the aforementioned embodiment, the hardware of the smart storage equipment and its connection to the server are described, and a smart logistic method for using the smart storage equipment and details about the smart logistic system are described herein. FIG. 4 is a flow chart illustrating the steps of meal or merchandise ordering and preparation in the smart logistic method according to an embodiment of the present disclosure. As shown in step S401, when the consumer wants to order a meal or merchandise, the consumer makes the order on the server of the smart logistic system through the first electronic device, wherein the first electronic device is, but not limited to, a smart phone or a computer. When making the order, the consumer needs to provide an order information to the server, wherein the order information includes a consumer information such as name and contact number, a vendor information such as name of the store which the order is placed to, a goods information such as meal or merchandise type and quantity, and a base-device-identification information such as location or identification number of the base device. In step S402, the server sends the order information to the second electronic device of the vendor to notify the vendor so the vendor can prepare the meal or merchandise. The second electronic device is, but not limited to, a smart phone or a computer. Next, the vendor, after meal or merchandise preparation, put the meal or merchandise in the logistic container in step S403. Step S404 is where the vendor uses the second electronic device to read the barcode of the logistic container to obtain the identification information of the logistic container and sends the identification information to the server so the server acknowledges the correspondence between the order information and the logistic container via the identification information and forms a package information which includes the order information and the identification information. The second electronic device of the vendor can also obtain the identification information of the logistic container by detection using near-field communication. After the server obtained the identification information of the logistic container, the transceiver control unit of the logistic container controls the cover lock to activate locking feature to lock the cover and the container body as shown in step S405, where the locking cannot be released before a condition is validated and so the cover is not opened which reduces food safety or merchandise security issues relating to the goods in the logistic container. Last, in step S406, the logistic container carrying/loaded with the meal or merchandise is delivered by the delivery person based on the base-device-identification information in the order information. The delivery person can deliver multiple logistic containers that are designated to the same base device in a batch.

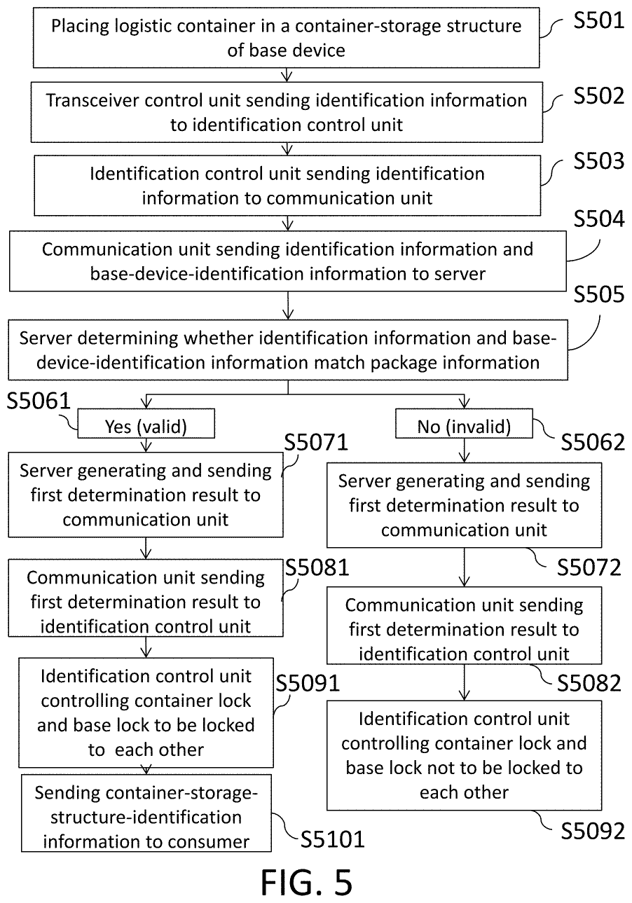

After the delivery person delivers the logistic container to the base device designated by the consumer based on the base-device-identification information in the order information, the loading process of the logistic container into the base device is shown in FIG. 5. FIG. 5 illustrates the steps of meal or merchandise delivery by the delivery person in the smart logistic method according to an embodiment of the present disclosure. In step S501, the delivery person places the logistic container randomly in any one of the container-storage structures that is unoccupied by other logistic container in the base device. Then, the transceiver control unit of the logistic container and the identification control unit of the container-storage structure correspond to each other in step S502, wherein the transceiver control unit of the logistic container sends the identification information to the identification control unit of the container-storage structure. Next in step S503, the identification control unit of the container-storage structure sends the identification information to the communication unit through its electrical connection to the communication unit. In step S504, the communication unit of the base device sends the identification information and the base-device-identification information to the server, such that the server acknowledges the correspondence between the identification information of the logistic container and the container-storage structure of the base device, in other words, information about which container-storage structure of the base device is the logistic container stored in. As shown in step S505, the server checks the package information to which the identification information of the logistic container belongs to determine/verify whether the identification information and the base-device-identification-information match the package information. When the server determines/verifies the identification information and the base-device-identification information match the package information, the server determines the identification information and the base-device-identification information are valid in step S5061 and further generates and sends a first determination result to the communication unit in step S5071. The communication unit of the base device sends the first determination result to the identification control unit in step S5091 so that the identification control unit controls the container lock and the base lock to lock with each other in step S5091, in other words, the locking between the container lock and the base lock is enforced. Whereas when the server determines the identification information and the base-device-identification-information do not match the package information, the server determines them to be invalid in step S5062 and further generates and sends a first determination result to the communication unit in step S5072. The communication unit of the base device sends the first determination result to the identification control unit in step S5082 so that the identification control unit controls the container lock and the base lock not to lock with each other in step S5092, in other words, the locking between the container lock and the base lock is not enforced.

When a valid status is determined by the server, the identification control unit of the container-storage structure in the base device can send the identification information of the logistic container and a container-storage-structure-identification information of the container-storage structure to the communication unit. More specifically, the communication unit sends the identification information of the logistic container and the container-storage-structure-identification information of the container-storage structure to the server for the server to generate a pick-up information, wherein the pick-up information includes the package information and the container-storage-structure-identification information. Subsequently in step S5101, the server further sends the container-storage-structure-identification information to the first electronic device to notify the consumer at which container-storage structure to pick-up their goods. When an invalid status is determined by the server, the identification control unit of the container-storage structure in the base device controls the container-storage structure to eject the logistic container. Each of the identification information of the logistic container, the base-device-identification information, and the container-storage-structure-identification information has an individual and unique identification code, so that the server knows which logistic container is placed in which container-storage structure of which base device.

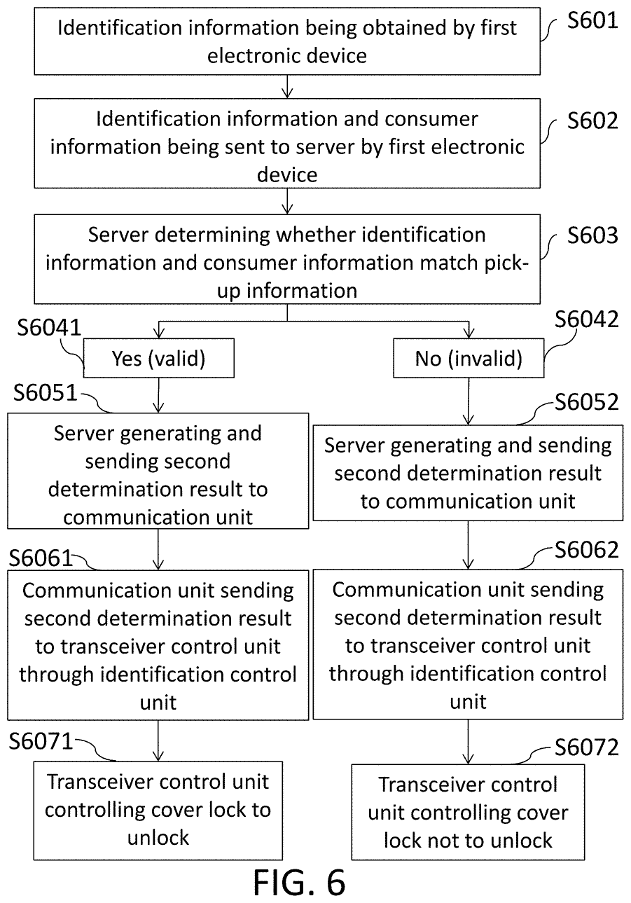

Through the first electronic device, the consumer is able to get the location of the logistic container that belongs to their order or is loaded with their ordered goods. FIG. 6 is a flow chart illustrating the steps of the consumer picking-up their order in the smart logistic method according to an embodiment of the present disclosure. In step S601, the consumer uses the first electronic device to read the barcode of the logistic container to obtain the identification information of the logistic container, and then in step S602, the consumer sends the identification information of the logistic container and the consumer information to the server through the first electronic device. In step S603, the server checks the pick-up information to which the identification information of the logistic container belongs to determine/verify whether the consumer information and the identification information match the pick-up information. When the server determines/verifies the consumer information and the identification information match the pick-up information, the server determines the consumer information and the identification information are valid in step S6041 and further generates and sends a second determination result to the communication unit in step S6051, wherein the server sends the container-storage-structure-identification information of the container-storage structure to the communication unit so that the communication unit can send the second determination result to the transceiver control unit based on the container-storage-structure-identification information. In step S6061, the communication unit of the base device sends the second determination result to the transceiver control unit through the identification control unit so that the transceiver control unit controls the cover lock to unlock in step S6071 and the consumer can take out the meal or merchandise. Whereas when the server determines the consumer information and the identification information do not match the pick-up information, the server determines them to be invalid in step S6042 and further generates a second determination result and sends it to the communication unit in step S6052. In step S6062, the communication unit of the base device sends the second determination result to the transceiver control unit through the identification control unit so that in step S6072, the transceiver control unit controls the cover lock not to unlock and to remain locked and the server further sends a first prompt message to notify the consumer that their attempt to pick-up the goods has failed.

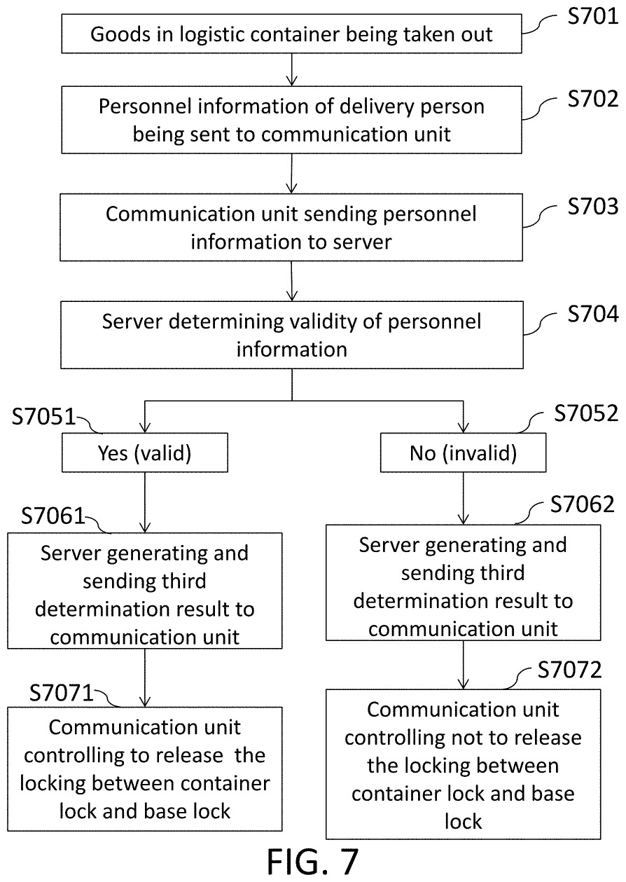

After the consumer takes out the meal or merchandise, the logistic container with unlocked cover lock is retrieved by the delivery person for recycled use. FIG. 7 is the steps of the delivery person retrieving the logistic container in the smart logistic method according to an embodiment of the present disclosure. In step S701, the consumer takes out the goods/meal or merchandise in the logistic container and in step S702, when the delivery person is at the location of the base device, the delivery person sends a personnel information to the communication unit. For example, the delivery person taps the employee identification card to the communication unit of the base device for detection, or sends the personnel information to the communication unit through a third electronic device, the present disclosure is not limited thereby. Next in step S703, the communication unit sends the personnel information to the server for the server to determine whether the personnel information is valid in step S704. When the server determines the personnel information to be valid in step S7051, the server generates a third determination result and sends it to the communication unit in step S7061 so that the communication unit controls the releasing of the locking between the container lock and the base lock and the ejection of the logistic container from the container-storage structure in step S7071. Hence, the delivery person can remove all of the logistic containers with unlocked cover lock. When the server determines the personnel information to be invalid as shown in step S7052, the server generates and sends a third determination result to the communication unit in step S7062, and the communication unit controls not to release/unlock the locking between the container lock and the base lock and further sends a second prompt message to the delivery person in step S7072 to notify the delivery person that the attempt to release the logistic container has failed.

Further, the aforementioned base devices can serve as transfer points for logistics operations, especially for long-haul logistic operations. When the logistic container is transported by one delivery person to one of the base devices, the logistic container is locked to the base device. Subsequently, another delivery person would arrive at the base device and unlock the locking between the logistic container and the base device so as to transport the logistic container to the next base device. As such, the plurality of base devices act as hubs for temporarily storing as well as transferring logistic containers in long-haul logistic operations, and the logistic container in the base device of its final destination is opened by the consumer unlocking a cover lock of the logistic container and therefore the consumer gets the food or merchandise inside of the logistic container.

In view of above, the technical benefits of the smart storage equipment for smart logistic system and the smart logistic method using the smart storage equipment as described by the embodiments of the present disclosure, in comparison to the conventional technology, are described below.

The conventional logistic systems deliver goods by having the delivery person meeting face-to-face with the consumer or by having the consumer pick-up their goods at convenient stores, but these two delivery methods are both time-restricted and so the receipt efficiency is affected when the consumer shops online. On the other hand, the smart storage equipment for smart logistic system and the smart logistic method using the smart storage equipment of the present disclosure provide a way to deliver goods where the delivery person and the consumer do not need to meet face-to-face and where multiple consumers can pick-up their goods at the same base device at the same time without having to line up, which eliminates line-up time. Moreover, in the smart storage equipment for smart logistic system and the smart logistic method using the smart storage equipment of the present disclosure, the logistic container includes cover lock which minimizes the chance of the goods being touched by a third-party and an in turn reduces factors contributing to consumer disputes, and when food is the goods to be delivered, the hygienic of the food is increased.

The above disclosure is only the preferred embodiment of the present disclosure, and not used for limiting the scope of the present disclosure. All equivalent variations and modifications on the basis of shapes, structures, features and spirits described in claims of the present disclosure should be included in the claims of the present disclosure.

1. A smart storage equipment for smart logistic system, the smart storage equipment comprising:
a base device, comprising:
a base comprising a plurality of container-storage structures, each of the plurality of container-storage structures comprises a container lock and an identification control unit; and
a communication unit disposed in the base, wherein the identification control unit is electrically connected to the communication unit and the communication unit is communicatively connected to a server; and
at least one logistic container, comprising a cover, a container body, and a cover lock for locking the cover and the container body, wherein the container body comprises an identification information, a base lock corresponding to the container lock, and a transceiver control unit;
wherein when the logistic container is placed in the container-storage structure, the transceiver control unit sends the identification information of the logistic container to the identification control unit of the container-storage structure, and a locking between the container lock and the base lock is controlled based on the validity of the identification information; and
wherein the transceiver control unit controls an unlocking of the cover lock based on whether a consumer information of a consumer and the identification information of the logistic container match a pick-up information in the server.

2. The smart storage equipment of claim 1, wherein the server obtains an order information from a first electronic device of the consumer and sends the order information to a second electronic device of a vendor corresponding to the order information, a good corresponding to the order information is put into the logistic container by the vendor and the second electronic device obtains the identification information, the transceiver control unit controls the cover lock to lock the cover and the container body, and the second electronic device sends the identification information to the server to from a package information, wherein the order information comprises the consumer information, a vendor information, a goods information, and a base-device-identification information, and the package information comprises the order information and the identification information.

3. The smart storage equipment of claim 2, wherein the identification control unit of the container-storage structure sends the identification information to the communication unit, the communication unit sends the identification information and the base-device-identification information to the server, the server determines the validity of the identification information by verifying whether the identification information and the base-device-identification information match the package information and generates and sends a first determination result to the communication unit, the communication unit sends the first determination result to the identification control unit, and the identification control unit controls the locking between the container lock and the base lock according to the first determination result.

4. The smart storage equipment of claim 3, wherein when the identification information is valid, the identification control unit enforces the locking between the container lock and the base lock and sends a container-storage-structure-identification information of the container-storage structure to the communication unit, the communication unit sends the identification information of the logistic container and the container-storage-structure-identification information to the server to generate the pick-up information, and the server sends the container-storage-structure-identification information to the first electronic device of the consumer, wherein the pick-up information comprises the package information and the container-storage-structure-identification information; and when the identification information is invalid, the identification control unit controls the container-storage structure to eject the logistic container.

5. The smart storage equipment of claim 1, wherein the identification information of the logistic container is obtained by a first electronic device of the consumer, the consumer information and the identification information are sent to the server by the first electronic device, the server determines whether the consumer information and the identification information match the pick-up information to generate and send a second determination result to the communication unit, the communication unit sends the second determination result to the transceiver control unit through the identification control unit, and the transceiver control unit controls the unlocking of the cover lock according to the second determination result.

6. The smart storage equipment of claim 5, wherein:
when the consumer information and the identification information match the pick-up information, the server sends a container-storage-structure-identification information of the container-storage structure to the communication unit, the communication unit sends the second determination result to the transceiver control unit based on the container-storage-structure-identification information, the transceiver control unit unlocks the cover lock; and
when the consumer information and the identification information do not match the pick-up information, the transceiver control unit does not unlock the cover lock and the server sends a first prompt message to the consumer.

7. The smart storage equipment of claim 1, wherein the transceiver control unit stores the identification information and the logistic container further comprises a barcode marked on the container body, wherein the barcode contains the identification information.

8. The smart storage equipment of claim 1, wherein a personnel information of a delivery person is sent to the communication unit, and a release of the locking between the container lock of the logistic container with unlocked cover lock and the base lock is controlled based on the personnel information, and after the locking between the container lock of the logistic container with unlocked cover lock and the base lock is released, the logistic container is ejected from the container-storage structure.

9. The smart storage equipment of claim 8, wherein the communication unit sends the personnel information to the server, the server determines the validity of the personnel information to generate a third determination result to the communication unit; when the personnel information is valid, the locking between the container lock of the logistic container with unlocked cover lock and the base lock is released, and the logistic container is ejected from the container-storage structure; and when the personnel information is invalid, the communication unit sends a second prompt message to the delivery person.

10. The smart storage equipment of claim 1, wherein the logistic container is a logistic container with thermal insulation.

11. The smart storage equipment of claim 1, wherein the logistic container further comprises a battery for providing electric power or an induction circuit for sensing an electromagnetic wave to obtain electric power.

12. A smart logistic system comprising:
a smart storage equipment as described in claim 1; and
a server.

13. A smart logistic method comprising:
providing a smart storage equipment, wherein the smart storage equipment comprises:
a base device, comprising:
a base comprising a plurality of container-storage structures, wherein each of the container-storage structures comprises a container lock and an identification control unit; and
a communication unit disposed in the base, wherein the identification control unit is electrically connected to the communication unit and the communication unit is communicatively connected to a server; and
at least one logistic container comprising a cover, a container body, and a cover lock for locking the cover and the container body, wherein the container body comprises an identification information, a base lock corresponding to the container lock, and a transceiver control unit;
placing the logistic container in the container-storage structure;
the transceiver control unit sending the identification information of the logistic container to the identification control unit of the container-storage structure and controlling a locking between the container lock and the base lock based on a validity of the identification information; and
the transceiver control unit controlling an unlocking of the cover lock based on whether a consumer information of a consumer and the identification information of the logistic container match a pick-up information in the server.

14. The smart logistic method of claim 13, further comprising:
the server obtaining an order information from a first electronic device of the consumer and sending the order information to a second electronic device of a vendor corresponding to the order information;
the second electronic device obtaining the identification information after a good corresponding to the order information is put into the logistic container by the vendor;
the transceiver control unit controlling the cover lock to lock the cover and the container body; and
the second electronic device sending the identification information to the server to form a package information, wherein the order information comprises the consumer information, a vendor information, a goods information, and a base-device-identification information, and the package information comprises the order information and the identification information.

15. The smart logistic method of claim 14, further comprising:
the identification control unit of the container-storage structure sending the identification information to the communication unit;
the communication unit sending the identification information and the base-device-identification information to the server;
the server determining a validity of the identification information by verifying whether the identification information and the base-device-identification information match the package information;
the server generating and sending a first determination result to the communication unit;
the communication unit sending the first determination result to the identification control unit; and
the identification control unit controlling the locking between the container lock and the base lock according to the first determination result.

16. The smart logistic method of claim 15, wherein:
when the identification information is valid, the identification control unit enforces the locking between the container lock and the base lock and sends a container-storage-structure-identification information of the container-storage structure to the communication unit, the communication unit sends the identification information of the logistic container and the container-storage-structure-identification information to the server for generating the pick-up information, and the server sends the container-storage-structure-identification information to the first electronic device of the consumer, wherein the pick-up information comprises the package information and the container-storage-structure-identification information; and
when the identification information is invalid, the identification control unit controls the container-storage structure to eject the logistic container.

17. The smart logistic method of claim 13, further comprising:
the server receiving the consumer information and the identification information from a first electronic device of the consumer, wherein the identification information is obtained by the first electronic device; and
the server determining whether the consumer information and the identification information match the pick-up information and generating and sending a second determination result to the communication unit;
the communication unit sending the second determination result to the transceiver control unit through the identification control unit; and
the transceiver control unit controlling the unlocking of the cover lock according to the second determination result.

18. The smart logistic method of claim 17, wherein:
when the consumer information and the identification information match the pick-up information, the server sends a container-storage-structure-identification information of the container-storage structure to the communication unit, the communication unit sends the second determination result to the transceiver control unit based on the container-storage-identification-structure-identification information, and the transceiver control unit unlocks the cover lock; and when the consumer information and the identification information do not match to the pick-up information, the transceiver control unit does not unlock the cover lock and the server sends a first prompt message to the consumer.

19. The smart logistic method of claim 13, wherein the communication unit receives a personnel information of a delivery person, and a release of the locking between the container lock of the logistic container with unlocked cover lock and the base lock is controlled based on the personnel information, and after the locking between the container lock of the logistic container with unlocked cover lock and the base lock is released, the logistic container is ejected from the container-storage structure.

20. The smart logistic method of claim 19, wherein the communication unit sends the personnel information to the server, the server determines a validity of the personnel information to generate a third determination result to the communication unit; when the personnel information is valid, the locking between the container lock of the logistic container with unlocked cover lock and the base lock is released and the logistic container is rejected from the container-storing structure; and when the personnel information is invalid, the communication unit sends a second prompt message to the delivery person.
